(19) United States
(12) Patent Application Publication
(10) Pub. No.: US 2019/0052388 A1
(43) Pub. Date: Feb. 14, 2019

(54) SYSTEM AND METHOD FOR OPTICAL SIGNAL TRANSMISSION

(71) Applicant: ZTE Corporation, Shenzhen (CN)

(72) Inventors: Jianjun Yu, Basking Ridge, NJ (US); Jianyang Shi, Morristown, NJ (US); Junwen Zhang, Randolph, NJ (US); Xin Xiao, Parsippany, NJ (US)

(21) Appl. No.: 15/676,929

(22) Filed: Aug. 14, 2017

(51) Int. Cl. H04J 14/02; H04B 10/2507; H04B 10/035; H04B 10/077; H04B 10/2513; H04B 10/2519; H04B 10/2525

(52) U.S. Cl. CPC H04J 14/02; H04B 10/2507; H04B 10/035; H04B 10/0775; H04B 10/2531; H04B 10/2519; H04B 10/2525; H04B 2210/078; H04B 10/25133

(57) ABSTRACT

Methods and systems for optical signal transmission, particularly with carrier-less amplitude and phase (CAP) modulation and direct detection, are disclosed. In one exemplary aspect, a method of optical signal transmission is disclosed. The method includes receiving information bits at an input interface; mapping the information bits to a plurality of modulation symbols; separating in-phase (I) and quadrature (Q) components of the plurality of modulation symbols such that the I and Q components form a Hilbert pair in a resulting signal; pre-dispersing the resulting signal with an inverse of a phase delay of an expected chromatic dispersion to obtain a pre-dispersed signal; converting the pre-dispersed signal from digital domain to analog domain using a digital to analog conversion circuit; performing modulation of an output of the digital to analog conversion circuit to generate an output signal; and transmitting, over an optical transmission medium, the output signal from the modulation.

### TECHNICAL FIELD

This patent document relates to digital communication, and, in one aspect, optical communication systems.

### BACKGROUND

There is an ever-growing demand for data communication in application areas such as wireless communication, fiber optic communication and so on. The demand on core networks is especially higher because not only are user devices such as smartphones and computers using more and more bandwidth due to multimedia applications, but also the total number of devices for which data is carried over core networks is increasing. Equipment manufacturers and network operators are continually looking for ways to meet the demand for ultra-high data rate transmission.

### SUMMARY OF PARTICULAR EMBODIMENTS

The present document discloses techniques for optical communication. In particular, methods and systems for optical signal transmission with carrier-less amplitude and phase (CAP) modulation and direct detection are disclosed.

In one exemplary aspect, a method of optical signal transmission is disclosed. The method includes receiving information bits at an input interface; mapping the information bits to a plurality of modulation symbols; separating in-phase (I) and quadrature (Q) components of the plurality of modulation symbols such that the I and Q components form a Hilbert pair in a resulting signal; pre-dispersing the resulting signal with an inverse of a phase delay of an expected chromatic dispersion to obtain a pre-dispersed signal; converting the pre-dispersed signal from digital domain to analog domain using a digital to analog conversion circuit; performing modulation of an output of the digital to analog conversion circuit to generate an output signal; and transmitting, over an optical transmission medium, the output signal from the modulation.

In another exemplary aspect, a method of optical signal reception is disclosed. The method includes receiving a carrier-less amplitude and phase (CAP) modulated optical signal over an optical transmission medium, wherein the optical signal comprises I and Q components forming a Hilbert pair, the digital signal pre-dispersed with an inverse of a phase delay of chromatic dispersion; extracting symbol estimates from the optical signal using decision-directed least mean squares (DD-LMS); and de-mapping the symbol estimates to obtain information bits modulated in the CAP-modulated optical signal.

In another example aspect, an optical communication apparatus that includes a processor and an optical transceiver are disclosed. The processor is configured to implement one of the method described above.

The above and other aspects and their implementations are described in greater detail in the drawings, the description and the claims.

### BRIEF DESCRIPTION OF THE DRAWINGS

FIG. 1 shows an exemplary optical communication system in which the presently disclosed technology can be practiced.

FIG. 2 shows a block diagram of an example communication apparatus.

FIG. 3 shows a block diagram of an exemplary process of generating a carrier-less amplitude and phase modulation-16 quadrature amplitude modulation (CAP-16) signal.

FIG. 4 shows a block diagram of an exemplary process of offline processing the CAP-16 signal.

FIG. 5A shows an exemplary experimental setup using a dual-drive Mach-Zehnder modulator (DDMZM).

FIG. 5B shows an exemplary experimental setup using a dual-drive Mach-Zehnder modulator (DDMZM) and dispersion compensating fiber (DCF).

FIG. 5C shows an exemplary experimental setup using an in-phase and quadrature (IQ) modulator.

FIG. 6 shows an exemplary graph of bit error ratio (BER) performance comparison of CAP-16 back-to-back (BTB) transmission and transmission over 80 km standard-single-mode-fiber (SSMF).

FIG. 7 shows an exemplary relationship between Complementary Cumulative Distribution Function (CCDF) and Peak to Average Power Ratio (PAPR).

FIG. 8 shows an exemplary graph of BER performance comparison of using DCF and pre-chromatic-dispersion (pre-CD) method for CAP modulation.

FIG. 9 shows an exemplary graph of BER performance comparison of applying pre-CD and single sideband (SSB) for CAP modulation.

FIG. 10 shows an exemplary graph of BER performance comparison of applying pre-CD and single sideband (SSB) for CAP modulation under different fiber lengths.

FIG. 11 shows an exemplary graph of BER performance comparison of DDMZM and IQ modulators in the BTB case.

FIG. 12 shows an exemplary graph of BER performance versus the received optical power using pre-CD method with IQ modulator over 400 km SSMF.

FIG. 13 shows an exemplary graph of the BER performance versus the transmission distance utilizing pre-CD method and SSB with the IQ modulator.

FIG. 14 shows exemplary optical spectra of DSB and SSB signals for CAP over 400 km and 480 km SSMF.

FIG. 15 is a flowchart representation of an optical communication method.

FIG. 16 is another flowchart representation of an optical communication method.

### DETAILED DESCRIPTION

Recently, the demand for ultra-high data rate optical transmission has been continuously growing in optical transport networks, metro networks, and access networks. Wavelength Division Multiplexing (WDM) and even Ultra Dense WDM (UDWDM) with advanced modulation formats are widely used in coherent systems to realize the most promising solutions for 400 Gb/s and 1 Tb/s transmission. A metro network, as a medium distance transmission system, poses a special challenge of transmission capacity and cost. In particular, for metro networks, both transmission distance and cost should be considered in the architecture to achieve 100 Gb/s per lane. Compared with coherent receivers, direct-detection (DD) optical transmission is considered as a more attractive and feasible solution in terms of system construction cost, computation complexity, and power consumption.

One advanced single carrier modulation format that uses low-cost and bandwidth limited optical components is carrier-less amplitude and phase modulation (CAP). Although many researchers have investigated advanced modulation formats for metro networks, there has been no 100 Gb CAP transmission reported over 400 km standard-single-mode-fiber (SSMF) using low-cost direct detection. The major reason is that long-haul transmission suffers chromatic dispersion (CD) penalties.

There are three main ways to compensate chromatic dispersion: pre-CD method, single sideband (SSB) method, and dispersion compensating fiber (DCF). Applying SSB or vestigial side band (VSB) is one way to overcome the CD limitation in systems with direct detection. For example, 100 Gb/s SSB DMT over 80 km fiber and 110.3 Gb/s VSB discrete multi-core (DMT) over 100 km fiber have been achieved. Pre-CD compensation is another way to suppress CD distortion. For example, 336 Gb/s PDM-64 QAM have been experimentally demonstrated with in-phase and quadrant (IQ) modulator over 40 km SSW. In another implementation, 56 Gb/s DMT over 320 km SSMF and 100 Gb/s DMT over 80 km SSMF with dual-drive Mach-Zehnder modulator (DDMZM) have been realized.

This patent document describes a transmission method using low-cost CAP modulation with direct detection. The method is capable of achieving a single-wavelength 100 G transmission over a long distance in metro networks. In one embodiment, a single-wave 100 G transmission was achieved over 480 km SSMF. A bit rate of 112 Gb/s/λ is achieved by utilizing CAP with commercial optical components (λ represents wavelength). This patent document also includes comparison of system performance between dispersion compensating fiber (DCF) and pre-CD compensation over 80 km SSMF, and evaluation of transmission performance of SSB and pre-CD signal with DDMZM and IQ modulator.

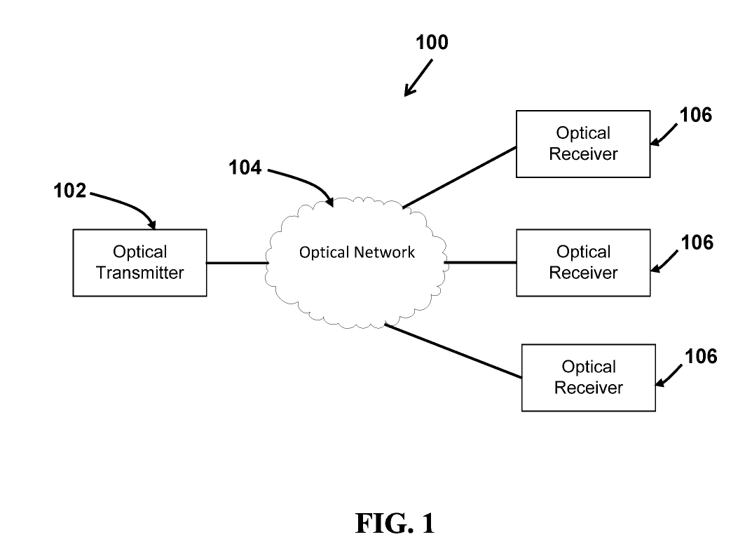

FIG. 1 depicts an optical communication system 100 in which the presently disclosed technology can be practiced. One or more optical transmitters 102 are communicatively coupled via an optical network 104 with one or more optical receivers 106. The optical network 104 may comprise optical fibers that extend in length from several hundred feet (e.g., last mile drop) to several thousands of kilometers (long haul networks). The transmitted optical signals may go through intermediate optical equipment such as amplifiers, repeaters, switch, etc., which are not shown in FIG. 1 for clarity. The techniques described in the present document may be implemented by the optical transmitter 102 and/or the optical receivers 106.

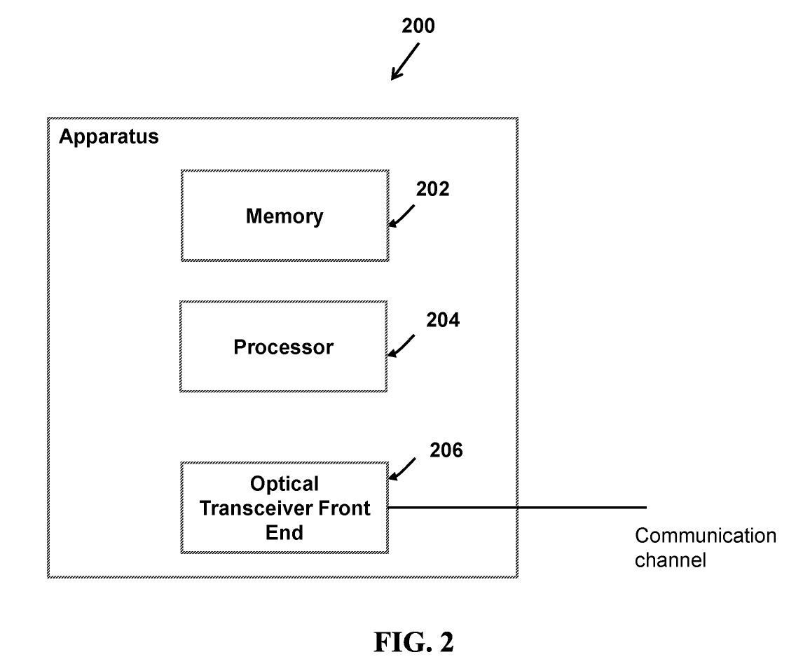

FIG. 2 is a block diagram of an example communication apparatus 200. The apparatus 200 may include one or more memories 202, one or more processors 204 and an optical receiver or transceiver front end 206 that is coupled with a communication link 208. The memory 202 may store processor-executable instructions and/or data during processor operation. The processor 204 may read instructions from the one or memories 202 and implement a technique described in the present document. The optical front end may be coupled to the processor and may receive transmissions from the communication link 208 and convert them into digital signals that are then processed by the processor 204 or other circuitry in the apparatus 200 (not shown in FIG. 2). The apparatus 200 may represent embodiment of the transmitter 102 or the receiver 106 and may be capable of implementing methods 1600 and 1500 described herein.

CAP-16 Format

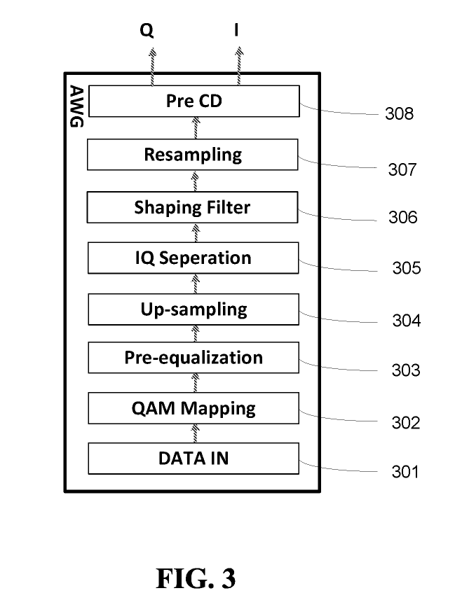

FIG. 3 shows a block diagram of an exemplary process of generating a CAP-16 signal. The process in this particular embodiment includes, at 301, receiving input data at an input interface. At 302, the data is first mapped into modulation symbols, e.g., complex symbols of a 16-QAM signal. Then, at 303, the modulation symbols are pre-equalized in time domain. For example, an inverted linear filter with 189 tap length can be used to perform the pre-equalization. After pre-equalization, the data can be up-sampled by a factor of four at 304. Then, the in-phase and quadrature (IQ) components are separated, at 305, to form a Hilbert pair in a resulting signal. A square-root-raised-cosine shaping filter with a roll-off factor of 0.1 can be applied at 306 to the resulting signal. In this particular embodiment, the center frequency is set as 15.6 GHz, while the baud rate of CAP-16 is 28 GBaud. The bit rate remains at 112 Gb/s. After the signal is resampled at 307, the signal is pre-dispersed with the inverse of the phase delay caused by chromatic dispersion (CD) at 308. The signal then becomes a complex signal due to pre-CD process. Real and imaginary parts of the signal then can be fed into the upper and lower arms of a DDMZM or IQ modulator.

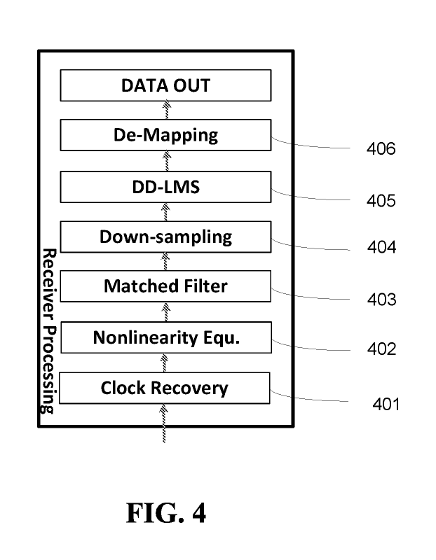

FIG. 4 shows a block diagram of an exemplary process implemented in a receiver of the CAP-16 signal. In some embodiments, the process may be implemented by performing offline processing the CAP-16 signal, e.g., in a digital signal processor. Alternatively, the process may be implemented using a combination of software and hardware circuits. some embodiments, after timing recovery, e.g., Gardner timing recovery (401), and the nonlinearity equalizer using a Least Mean Square (LMS) Volterra filter (402), the signal is sent into a matched filter (403) to separate the in-phase and quadrature components. The signal is then down-sampled (404). The bit error ratio (BER) performance of the final data is measured after the direct-detection LMS (DD-LMS) (405) and de-mapping (406) process.

Pre-CD Method

The main factor that limits the transmission distance for DSB signal is the power fading issue caused by chromatic dispersion. The general frequency domain channel response of CD is:

$$H ( w ) = exp ( - j \frac{DL {λ}^{2}}{4 π c} {w}^{2} ) \qquad Eq . ( 1 )$$

D is the dispersion parameter, L is the fiber length, λ is the carrier wavelength, and c is the speed of light. Eq. (1)'s corresponding time domain expression is:

$$h ( t ) = \sqrt{\frac{c}{jDL {λ}^{2}}} exp ( j \frac{π c}{DL {λ}^{2}} {t}^{2} ) \qquad Eq . ( 2 )$$

According to Eq. (2) and the square law detection, the final formula is presented as:

$${I}_{PD}^{2} ( t ) ∝ {cos}^{2} [ \frac{π DL {λ}^{2}}{c} {f}^{2} ] \qquad Eq . ( 3 )$$

When the phase sum of signal is

$$\frac{π}{2} + N * π ,$$

where N is an integer, the signal will suffer the destructive power fading. So the bandwidth of the first lobe is expressed as:

$${f}_{bandwidth} = \frac{c}{2 DL {λ}^{2}} \qquad Eq . ( 4 )$$

In order to compensate for the serious power fading, the modulated signal may be pre-distorted by the inverse of CD channel response. The pre-CD method, however, introduces the phase information to the signals: the signals now carries the phase information at the same time. This make the pre-CD method particularly suitable for DDMZM and/or IQ modulators.

Generation of SSB Signal

SSB signal is another way to avoid power fading caused by CD. A DDMZM consists of two parallel phase modulators (PMs) and they are driven with a bias difference of V_{π}/2. The output of the DDMZM can be expressed as:

$$\begin{matrix}{E}_{out} = \frac{\sqrt{2}}{2} {E}_{in} * \{ {e}^{j * [ \frac{π}{{V}_{π}} I ( t ) - \frac{π}{2} ]} + {e}^{j * [ \frac{π}{{V}_{π}} Q ( t ) ]} \} \\ = \frac{\sqrt{2}}{2} {E}_{in} * \{ - j * {e}^{j * [ \frac{π}{{V}_{π}} I ( t ) ]} + {e}^{j * [ \frac{π}{{V}_{π}} Q ( t ) ]} \} \\ \approx \frac{\sqrt{2}}{2} {E}_{in} * \{ - j * [ 1 + j * \frac{π}{{V}_{π}} I ( t ) ] + [ 1 + j * \frac{π}{{V}_{π}} Q ( t ) ] \} \\ = \frac{\sqrt{2}}{2} {E}_{in} * \{ \frac{π}{{V}_{π}} * [ I ( t ) + j * Q ( t ) ] + 1 - j \}\end{matrix} \qquad Eq . ( 5 )$$

From Eq. (5), it is observed that the electrical signal I(t)+j*Q(t) is linearly converted to the optical domain.

For the generation of SSB signal, the electrical signal I(t) is as a real signal x and the signal Q(t) is set as the corresponding Hilbert pair x. The output of x+j*\hat{x} is the analytic signal of x and is a single-band signal. Then, the optical domain expression could be:

Eₒᵤₜ=Eᵢₙ*+(x+j*\hat{x}) Eq. (6)

The output of Eq. (6) then becomes an optical single-band signal.

Example Setup and Results

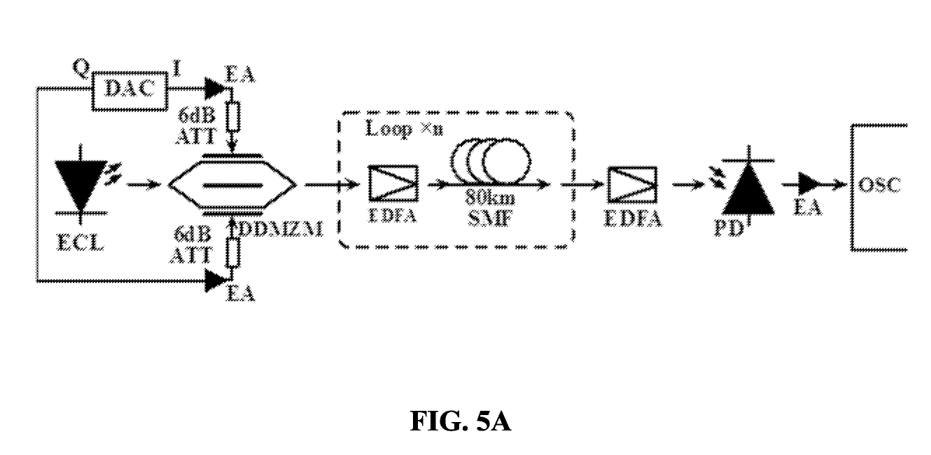

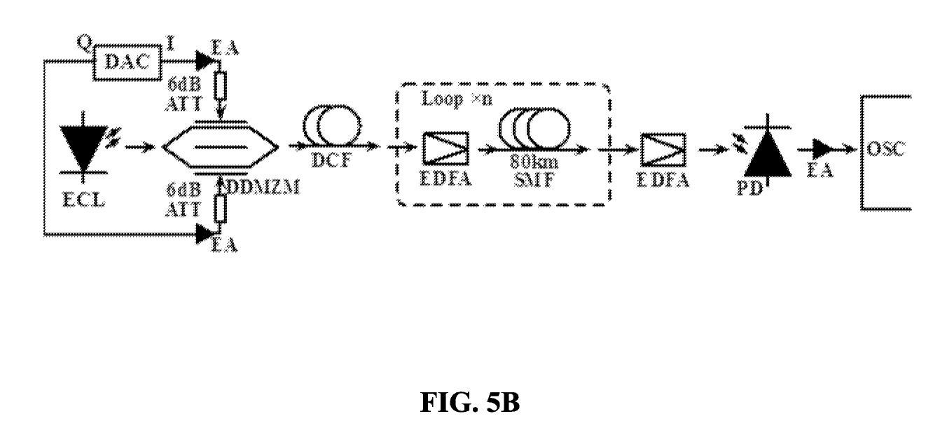

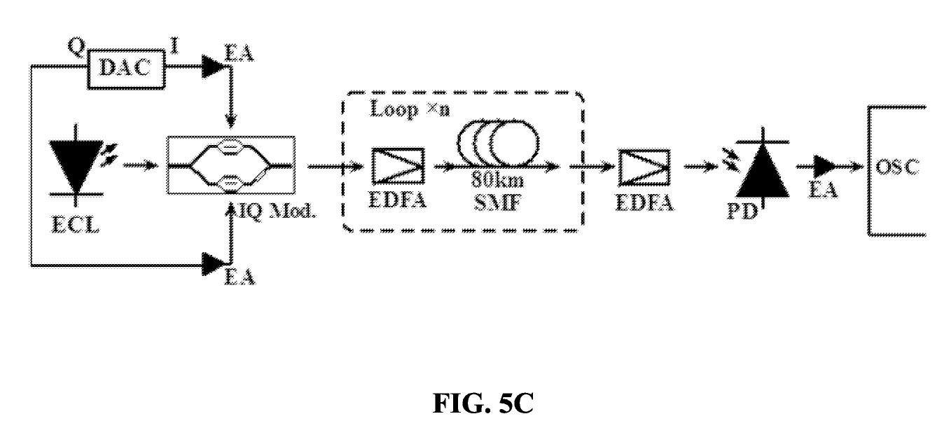

FIGS. 5A-5C show some exemplary setups. For example, the drive signals can be generated using an 81.92 GSa/s digital-to-analog converter (DAC) with 20 GHz bandwidth and an offline Matlab® program. Both DDMZM (35 GHz bandwidth) and IQ modulator (30 GHz bandwidth) are used in this experiment. The bias of the two parallel PMs in the DDMZM is driven with a bias difference of V_{π}/2 to achieve the function of IQ modulation, and IQ modulator is driven at the quarter point. Before driving the upper and lower arms of the modulator, the signals are amplified by electrical amplifiers (EAs). For example, 32 GHz bandwidth and 20 dB gain can be used. In some embodiments, 6 dB and 0 dB electrical attenuators for DDMZM and IQ modulator respectively are used to fit the linear region of the modulators. A continual wave (CW) light at 1542.9 nm is fed into the modulators. The fiber transmission loop consists of one Erbium-doped fiber amplifier (EDFA) and 80 km SSMF fiber. The signals are detected by one 50 GHz photo detector (PD) after amplified by an EDFA. Finally, the signals are sampled by a digital real-time oscilloscope with an 80 GSa/s sampling rate and 33 GHz electrical bandwidth.

In particular, FIG. 5A shows an exemplary setup using a dual-drive Mach-Zehnder modulator (DDMZM). FIG. 5B shows an exemplary setup using a dual-drive Mach-Zehnder modulator (DDMZM) and dispersion compensating fiber (DCF). FIG. 5C shows an exemplary setup using an in-phase and quadrature (IQ) modulator.

Comparison Between Pre-CD and DCF with DDMZM

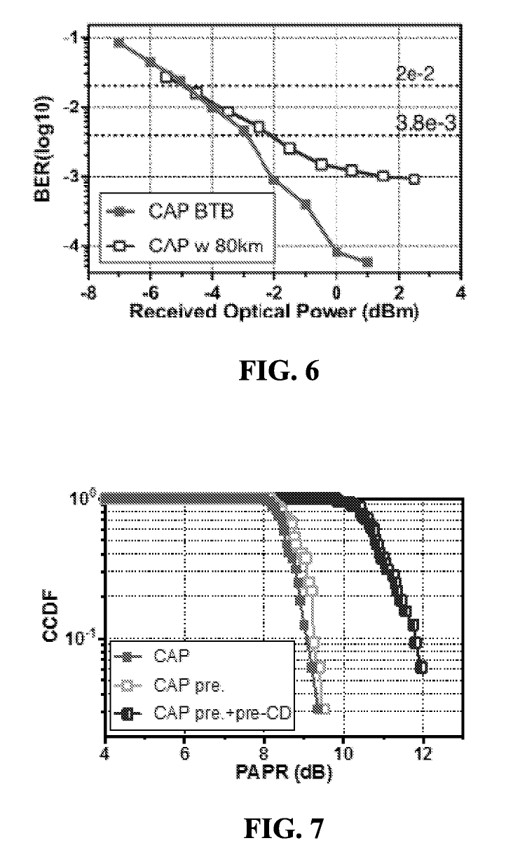

Firstly, the BER performance of CAP-16 in back-to-back (BTB) and 80 km SSMF cases is investigated. Dispersion compensating fiber (DCF) is used to compensate for the CD caused by 80 km fiber as shown in FIG. 6.

To study the effect of Peak to Average Power Ratio (PAPR), the PAPR of CAP is evaluated with different DSP processes. FIG. 7 shows an exemplary relationship between Complementary Cumulative Distribution Function (CCDF) and peak average to power ratio (PAPR). It has been observed that, after pre-equalization, PAPR gets a little higher. PAPR becomes much higher after employing pre-CD method.

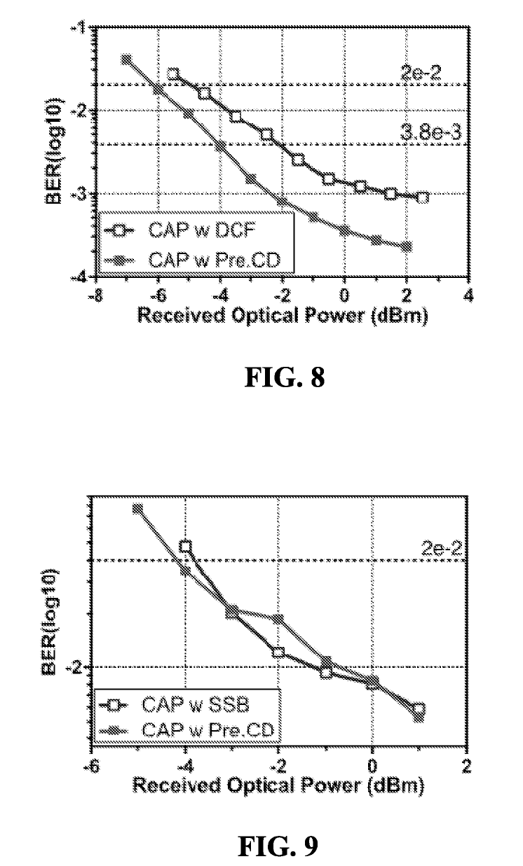

The BER performance between applying pre-CD and DCF fiber is then compared. FIG. 8 shows that using pre-CD method for CAP-16 signals can get about 2 dB receiver sensitivity gain at the hard decision (HD) forward error correction (FEC) threshold.

Comparison Between Pre-CD and SSB with DDMZM

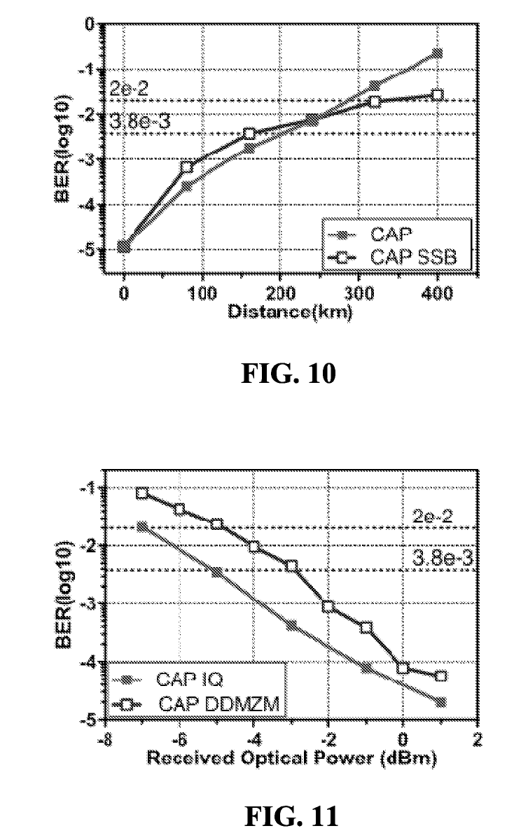

SSB is another way to overcome the CD limitation in the systems with direct detection. Comparison of the performance between applying pre-CD and SSB for CAP modulation is also conducted. The results are firstly obtained over 240 km SSMF transmission as shown in FIG. 9. In 240 km SSMF transmission, SSB signals slightly outperform pre-CD signals. FIG. 10 shows an additional comparison between applying pre-CD and SSB under different fiber lengths. When the transmission length is short (about less than 240 km), the pre-CD signal is better than the SSB signal. When the transmission distance increases, SSB has a better performance. One of the reasons for the performance variation is the nonlinearity of the DDMZM: the effect of the nonlinearity is sharply enhanced as the transmission distance increases.

Comparison Between DDMZM and IQ Modulator

As DDMZM is roughly similar as the IQ function, the performance of the IQ modulator is also investigated. FIG. 11 shows the BER performance versus received optical power of CAP-16 utilizing DDMZM and IQ modulators in the BTB case. Employing IQ modulator will get about 2 dB receiver sensitivity gain compared with DDMZM at the HD-FEC threshold.

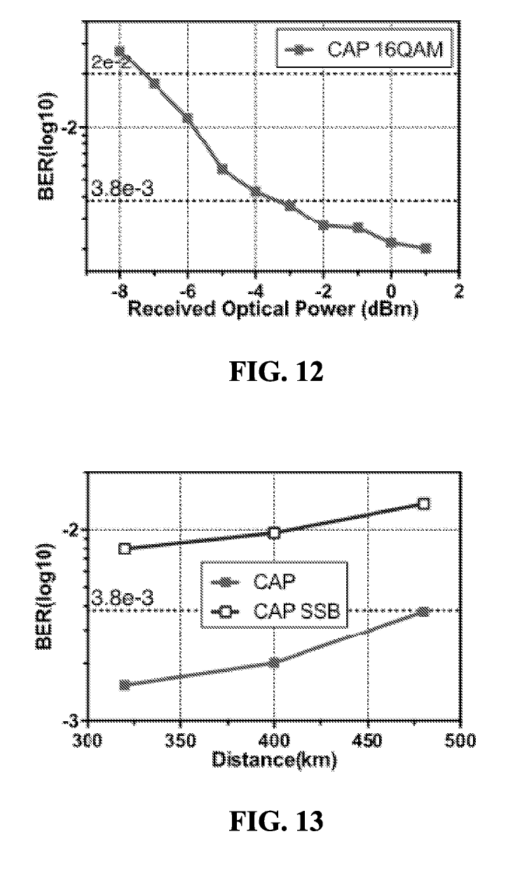

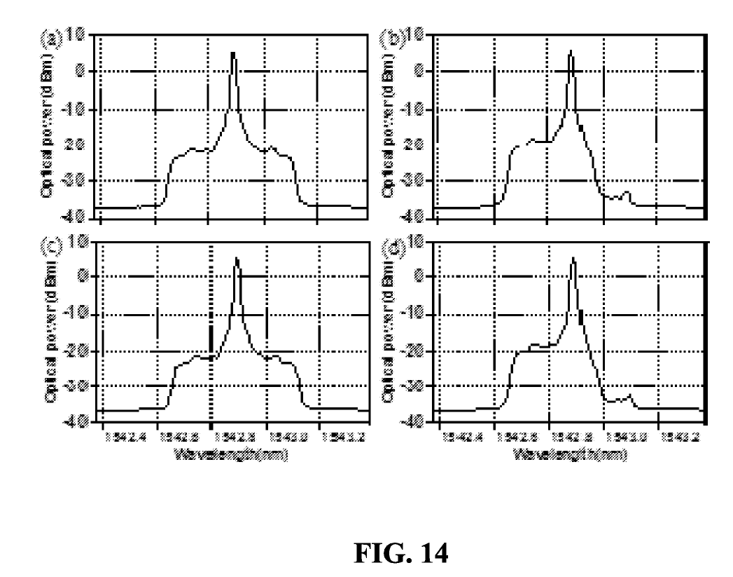

FIG. 12 shows the BER performance versus the received optical power utilizing pre-CD method with IQ modulator over 400 km SSMF. FIG. 13 shows the BER performance versus the transmission distance utilizing pre-CD method and SSB with the IQ modulator. Unlike the nonlinearity phenomenon of DDMZM, DSB signals are always better than SSB signals with the IQ modulator. Finally, a 480 km transmission is experimentally demonstrated utilizing CAP-16 under HD-FEC threshold of 3.8×10⁻³. This is so far the longest transmission distance for 100 G CAP signal per lane with direct-detection. FIG. 14 shows the optical spectra of DSB and SSB signals for CAP over 400 km and 480 km SSMF. The above results indicate that applying a IQ modulator could achieve better performance and acceptable cost in the metro networks.

It has been observed that, among the three main types of CD compensation methods including pre-CD, SSB, and DCF, DCF has the worst performance but introduces no extra DSP. Therefore, it is suitable for low-cost single-drive MZM. Utilizing pre-CD method, for example, can get about 2 dB receiver sensitivity gain at the HD-FEC threshold compared with DCF. Pre-CD signal shows consistent improvement over SSB signal for IQ modulator. However, when coupled with DDMZM, pre-CD signal shows performance variation due to the nonlinearity of the DDMZMs. In particular, when the transmission length is short (about less than 240 km), pre-CD signal is better than SSB signal when coupled with DDMZM. When the transmission distance increases, SSB shows a better performance. Therefore, among the methods and combinations examined herein, pre-CD method with an IQ modulator shows the best performance in the medium distance transmission system with direct detection.

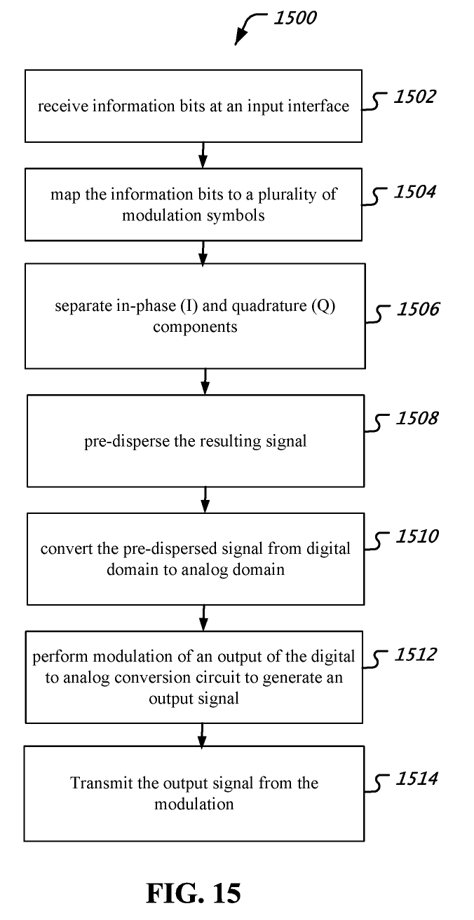

FIG. 15 is a flowchart representation of an optical communication method 1500. The method 1500 may be implemented by an optical transmitter apparatus (e.g., apparatus 102 or 106). The method 1500 includes, at 1502, receiving information bits at an input interface; at 1504, mapping the information bits to a plurality of modulation symbols; at 1506, separating in-phase (I) and quadrature (Q) components of the plurality of modulation symbols such that the I and Q components form a Hilbert pair in a resulting signal; at 1508, pre-dispersing the resulting signal with an inverse of a phase delay of an expected chromatic dispersion to obtain a pre-dispersed signal; at 1510, converting the pre-dispersed signal from digital domain to analog domain using a digital to analog conversion circuit; at 1512, performing modulation of an output of the digital to analog conversion circuit to generate an output signal; and, at 1514, transmitting, over an optical transmission medium, the output signal from the modulation.

In some embodiments, the method 1500 may further include techniques described with respect to FIG. 3.

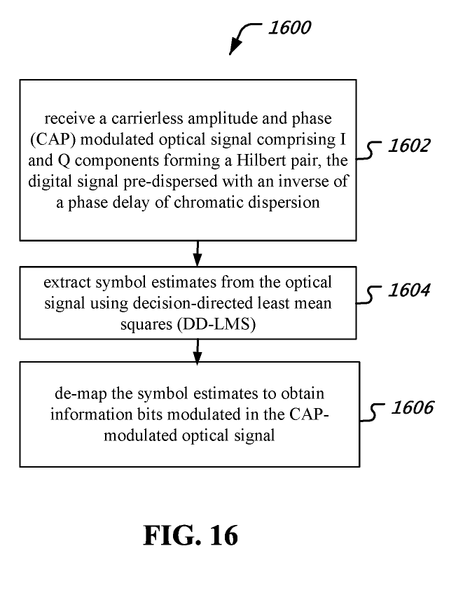

FIG. 16 is a flowchart representation of another optical communication method 1600. The method 1600 may be implemented by an optical receiver apparatus (e.g., 102 or 104 depicted in FIG. 1). The method 1600 includes, at 1602, receiving a carrierless amplitude and phase (CAP) modulated optical signal over an optical transmission medium, wherein the optical signal comprises I and Q components forming a Hilbert pair, the digital signal pre-dispersed with an inverse of a phase delay of chromatic dispersion; at 1604, extracting symbol estimates from the optical signal using decision-directed least mean squares (DD-LMS); and, at 1606, de-mapping the symbol estimates to obtain information bits modulated in the CAP-modulated optical signal. In some embodiments, the method 1600 may further include techniques described with respect to FIG. 4.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method of optical signal transmission, comprising:
receiving information bits at an input interface at a bit rate over 100 Gb/s;
mapping the information bits to a plurality of modulation symbols;
separating in-phase (I) and quadrature (Q) components of the plurality of modulation symbols such that the I and Q components form a Hilbert pair;
pre-dispersing the I and Q components of the Hilbert pair with an inverse of a phase delay of an expected chromatic dispersion to obtain a pre-dispersed complex signal;
converting the pre-dispersed complex signal from digital domain to analog domain using a digital to analog conversion circuit;
performing modulation of an output of the digital to analog conversion circuit to generate an output signal; and
transmitting, over an optical transmission medium having a length greater than 100 km, the output signal from the modulation.

2. The method of claim 1, comprising:
pre-equalizing the plurality of modulation symbols in time domain.

3. The method of claim 1, wherein the modulation is performed using an I-Q modulator.

4. The method of claim 1, wherein the modulation is performed using a dual-drive Mach-Zehnder modulator.

5. The method of claim 1, converting the output signal of modulation from an electrical domain to an optical domain.

6. A method of optical signal reception, comprising:
receiving an optical signal over an optical transmission medium having a length greater than 100 km;
converting the optical signal to a digital signal;
acquiring separate in-phase (I) and quadrature (Q) components of the digital signal, wherein the I and Q components form a Hilbert pair, and wherein the digital signal is pre-dispersed with an inverse of a phase delay of an expected chromatic dispersion using the I and Q components of the Hilbert pair;
extracting symbol estimates from the digital signal using decision-directed least mean squares (DD-LMS); and
de-mapping the symbol estimates to obtain information bits modulated in the optical signal.

7. The method of claim 6, wherein the optical signal is generated by modulating a signal using an I-Q modulator.

8. The method of claim 6, wherein the carrierless amplitude and phase modulated optical signal is generated by modulating a signal using a dual-drive Mach-Zehnder modulator.

9. An apparatus for optical signal transmission, comprising:
an input interface configured to receive information bits at a bit rate over 100 Gb/s;
a memory to store executable instructions; and
a processor in communication with the input interface, configured to read the executable instructions from the memory to:
map the information bits from the input interface to a plurality of modulation symbols,
separate in-phase (I) and quadrature (Q) components of the plurality of modulation symbols such that the I and Q components form a Hilbert pair, and
pre-disperse the I and Q components of the Hilbert pair with an inverse of a phase delay of an expected chromatic dispersion to obtain a pre-dispersed complex signal;
a digital to analog conversion circuit configured to convert the pre-dispersed complex signal from digital domain to analog domain;
a signal modulator configured to perform modulation of an output of the digital to analog conversion circuit to generate an output signal; and
a transmitter configured to transmit the output signal from the modulation over an optical transmission medium having a length greater than 100 km.

10. The apparatus of claim 9, wherein the processor is configured to:
pre-equalize the plurality of modulation symbols in time domain.

11. The apparatus of claim 9, wherein the signal modulator is an I-Q modulator.

12. The apparatus of claim 9, wherein the signal modulator is a dual-drive Mach-Zehnder modulator.

13. The apparatus of claim 9, wherein the output signal of the signal modulator is converted from an electrical domain to an optical domain.

14. An apparatus for optical signal reception, comprising:
a receiver configured to receive an optical signal over an optical transmission medium having a length greater than 100 km
a converter configured to convert the optical signal to a digital signal;
a filter configured to separate in-phase (I) and quadrature (Q) components of the digital signal, wherein the I and Q components form a Hilbert pair, and wherein the digital signal is pre-dispersed with an inverse of a phase delay of an expected chromatic dispersion using the I and Q components of the Hilbert pair;
a memory to store executable instructions; and
a processor in communication with the receiver, configured to read the executable instructions from the memory to:
extract symbol estimates from the digital signal using decision-directed least mean squares (DD-LMS); and
de-map the symbol estimates to obtain information bits modulated in the optical signal.

15. The apparatus of claim 14, wherein the optical signal is generated by modulating a signal using an I-Q modulator.

16. The apparatus of claim 14, wherein the optical signal is generated by modulating a signal using a dual-drive Mach-Zehnder modulator.
